(19) United States
(12) Patent Application Publication
(10) Pub. No.: US 2007/0229720 A1
(43) Pub. Date: Oct. 4, 2007

(54) Structure for Mounting a Light Engine in a Projection Display

(76) Inventors: Scott Joseph Duggan, Indianapolis, IN (US); Darin Bradley Ritter, Indianapolis, IN (US); Mark Alan Yoder, Carmel, IN (US)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(21) Appl. No.: 11/587,619

(22) PCT Filed: Apr. 26, 2005
(86) PCT No.: PCT/US05/14162

§ 371 Date: Oct. 27, 2006

Related U.S. Application Data
(60) Provisional application No. 60/567,924, filed on May 4, 2004.

(51) Int. Cl. H04N 5/74

(52) U.S. Cl. 348/759

(57) ABSTRACT

A projection display is described having two structural support arms for mounting the projection display on a stand or on a bracket. A light engine generates a light pattern to be displayed by the projection display. A bridge plate is positioned between the two support arms and the light engine is mounted on the bridge plate.

### CROSS-REFERENCE TO RELATED APPLICATIONS

This application claims the benefit of U.S. Provisional Patent Application Ser. No. 60/567,924, entitled “Structure for Mounting a Light Engine in a Projection Display” and filed May 4, 2004, which is incorporated by reference herein in its entirety.

### FIELD OF THE INVENTION

The invention related generally to a projection display and, in particular a light engine mounting system for a projection display.

### BACKGROUND OF THE INVENTION

Some new projection televisions include a light engine. Such projection televisions require very critical stability of the light engine in order to maintain image stability on the screen. This is primarily due to the steep “upangle” that the ray path follows. Small amounts of cabinet creep and/or movement due to thermal expansion mismatches can cause unacceptable image movement on the screen.

Previous projection displays have little or no “upangle” in their raypaths. The mounting arrangement used in such projection displays for the light engines is not nearly so sensitive to position and rotational tolerances. These projection displays have used conventional sheet metal and molded plastic mounting systems without regard to thermal expansion differences or creep.

### SUMMARY OF THE INVENTION

A projection display provides precise positioning and stable mounting of a light engine to support an upangle raypath. Two structural support arms are provided for mounting the projection display on a stand or on a bracket. A light engine generates a light pattern to be displayed by the projection display. A bridge plate spans the two support arms and the light engine is mounted on the bridge plate.

### BRIEF DESCRIPTION OF THE DRAWINGS

The invention will now be described by way of example with reference to the accompanying figures of which:

FIG. 1 is a front perspective view of the structural elements of a projection display according to an exemplary embodiment of the present invention with its screen omitted;

FIG. 2 is a front perspective view of the structural elements of the projection display of FIG. 1 with its cabinet omitted;

FIG. 3 is a back perspective view of the structural elements of the projection display of FIG. 1 with its cabinet omitted;

FIG. 4 is a front view of the projection display of the structural elements of the FIG. 1 showing a light engine mounting; and

FIG. 5 is a front perspective view of a projection display according to an exemplary embodiment of the invention.

### DETAILED DESCRIPTION

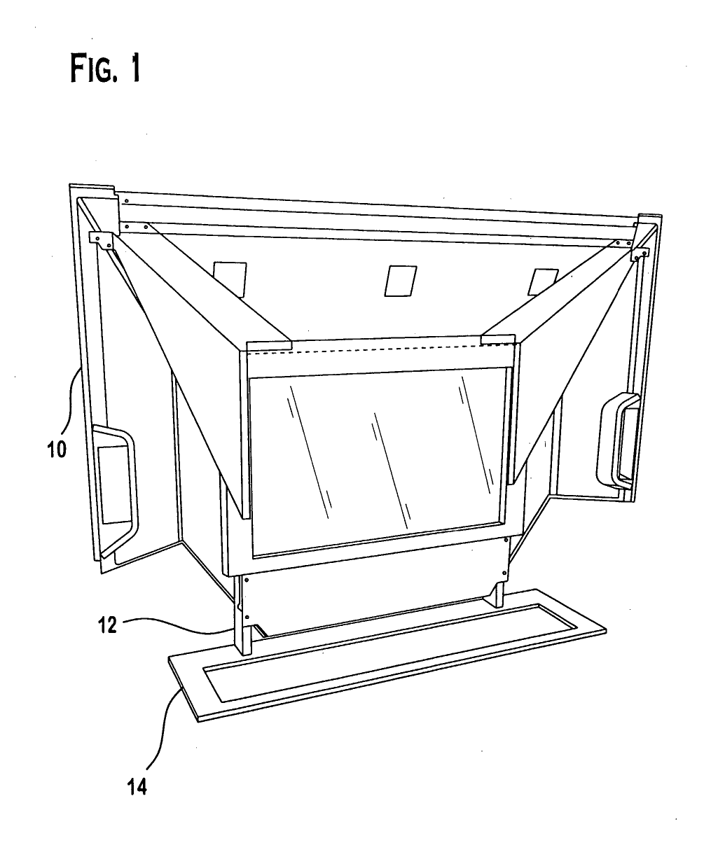

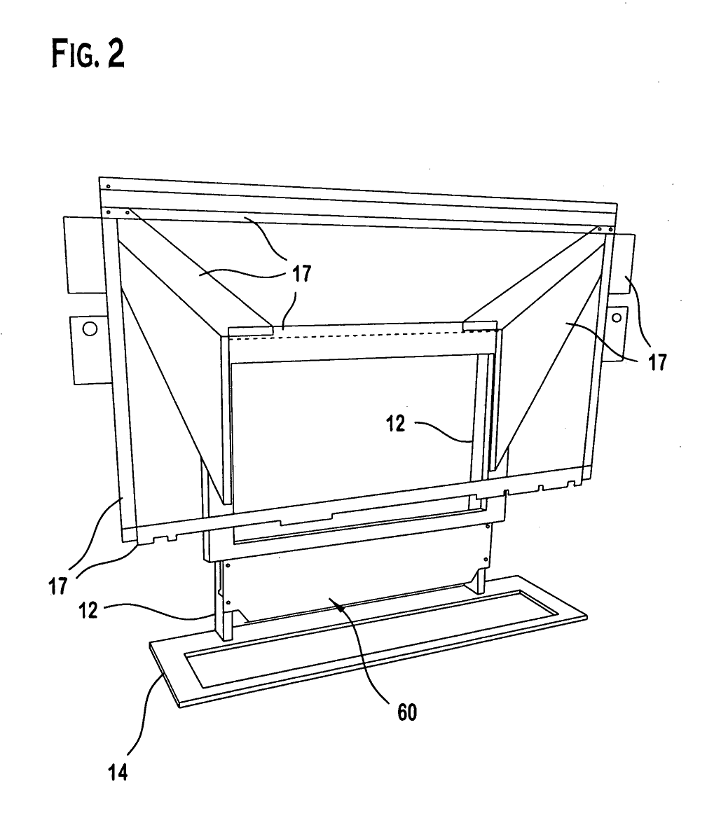

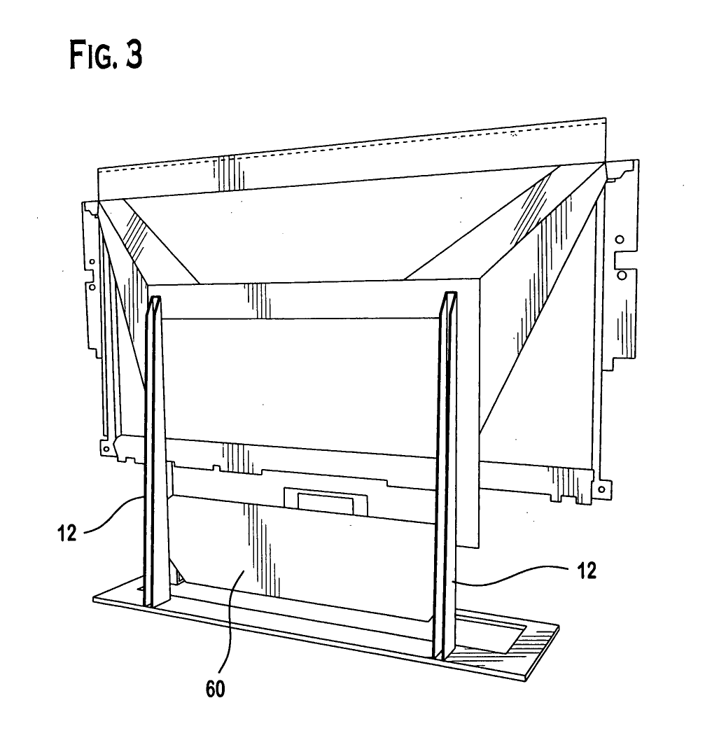

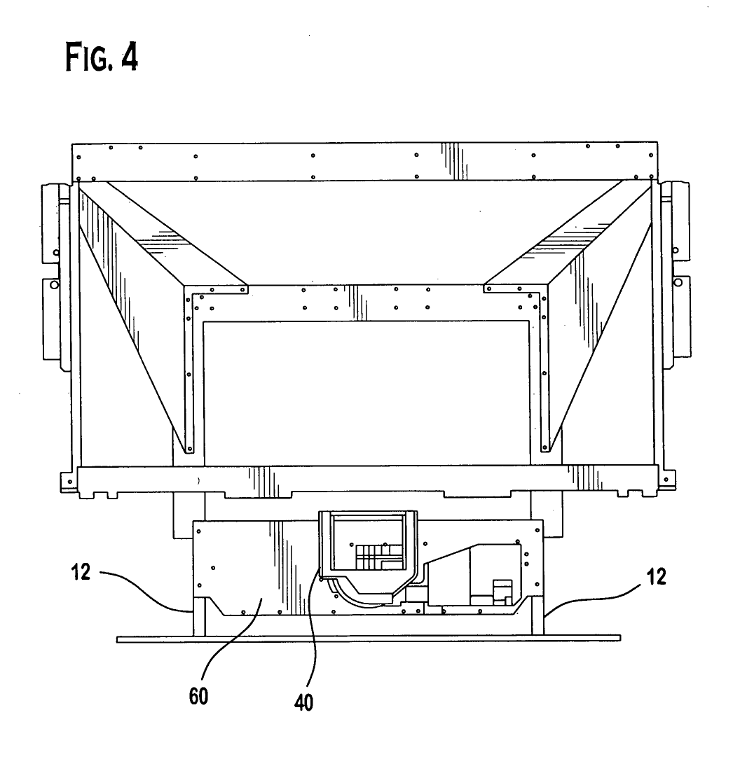

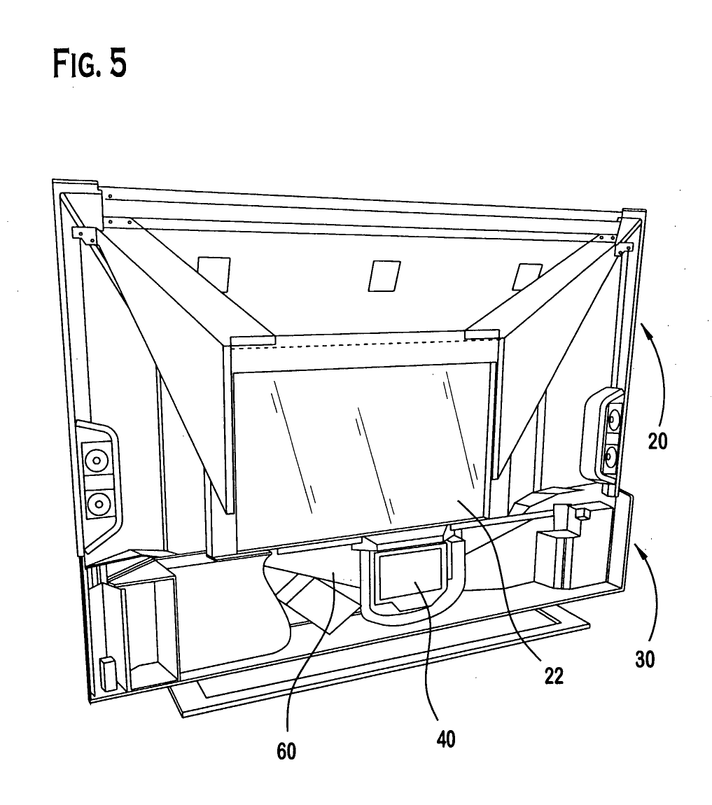

The present invention, shown in FIGS. 1-5, consists of a projection display in which a stiff bridge plate 60 spans a gap that is formed by two structural support arms 12 that are used to mount the projection display.

The structural support arms 12 are attached to a stand 14, as shown in the figures, for supporting the projection display on a floor or other substantially horizontal surface, or to a bracket (not shown) for mounting the projection display to a wall or other substantially non-horizontal surface. A support structure 17 is affixed to the structural support arms 12 opposite the stand 14. A cabinet 10 is fastened to the support arms 12 and the support structure 17. The cabinet 10 forms two cavities: a light box 20 in the upper portion of the cabinet and an electronics area 30 below the light box 20. A light engine 40 is positioned at the interface between the light box 20 and the electronics area 30, such that it can be electrically connected to electronics in the electronics area 30 while projecting a pattern of light upwardly into the light box 20.

To provide a slim profile, the light engine 40 projects the light pattern along an upangle raypath (i.e., at a steep angle), reflecting off of a mirror 22 at the back of the light box 20 and reflecting onto a screen (not shown) at the front of the light box 20. Due to this steep angle of the upangle raypath, small changes in the position of the light engine 40, such as the movements of the cabinet 10 due to thermal expansion, residual stress, or structural loading, can cause significant distortion of the projected image on the screen.

The support arms 12 are the only rigid structure in the projection display. The bridge plate 60 is designed to span between these two support arms 12 without being adversely influenced by the inherent instability of the plastic cabinet 10. The bridge plate is stiff, meaning that it provides sufficient stiffness, in view of its loading, to remain as stable as the support arms, preventing movement of the light engine 40 due to loading, thermal expansion, or other forces typically applied in a projection display system. Care should be taken to insure that attachment of parts with different coefficient of expansion allow for free expansion to prevent any adverse forces from being applied on the bridge plate 60.

Many different techniques may be used to construct the bridge plate 60 to provide the necessary stiffness. For example, the bridge plat 60 may be made from a rigid steel stamping assembly that approximates a “box”. The bridge plate 60 may alternatively be made from an aluminum extrusion or from a single steel stamping or a metal casting.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. A projection display, comprising:
two structural support arms for mounting the projection display on a stand or on a bracket;
a light engine for generating a light pattern to be displayed by the projection display;
and a bridge plate, positioned between the two support arms and having the light engine mounted thereon.

2. The projection display of claim 1 wherein the light pattern is projected along an upangle raypath.

3. The projection display of claim 1 wherein the bridge plate comprises a steel stamping assembly.

4. The projection display of claim 3 wherein the steel stamping assembly is in the form of a box beam.

5. The projection display of claim 1 wherein the bridge plate comprises an aluminum extrusion.

6. The projection display of claim 1 wherein the bridge plate comprises a single steel stamping.

7. The projection display of claim 1 wherein the bridge plate comprises a metal casting.

8. The projection display of claim 1, wherein parts with a coefficient of thermal expansion different from the bridge plate attached to the bridge plate by an attachment that allow for free expansion of the parts.

9. A projection display supported by two structural support arms and having a cabinet forming a light box mounted on the support arms, the projection display comprising:
a bridge plate affixed to said support arms and positioned in a gap formed between said support arms; and
a light engine mounted on said bridge plate for projecting light images upwardly into said light box along a precise upangle raypath.

10. The projection display of claim 9 wherein the bridge plate has sufficient stiffness to provide precise location of the light engine.

11. The projection display of claim 9 wherein the bridge plate has sufficient stiffness to prevent movement of the light engine.

12. The projection display of claim 9 wherein the cabinet is mounted to the support arms independently of the bridge plate.
